(19) United States
(12) Patent Application Publication
(10) Pub. No.: US 2004/0193352 A1
(43) Pub. Date: Sep. 30, 2004

(54) Control device for a vehicle

(76) Inventors: Sentaro Ito, Tokoname-shi (JP); Tetsuya Tokuda, Anjyo-shi (JP); Toshihisa Kato, Handa-shi (JP)

Correspondence Address: BURNS DOANE SWECKER & MATHIS L L P, POST OFFICE BOX 1404, ALEXANDRIA, VA, 22313-1404, US

(21) Appl. No.: 10/813,264

(22) Filed: Mar. 31, 2004

(30) Foreign Application Priority Data
Mar. 31, 2003 (JP) 2003-093977

(51) Int. Cl. G06F 19/00

(52) U.S. Cl. 701/70; 340/440

(57) ABSTRACT

This control device for a vehicle obtain a cant amount CANT by subtracting, from a detected actual lateral acceleration Gy, an estimated lateral acceleration Gyest corresponding to centrifugal force due to a turning run, calculated based upon the difference between the wheel speed at the left side of the vehicle body and the wheel speed at the right side of the vehicle body, by utilizing the fact that a lateral acceleration sensor 54 that detects the detected actual lateral acceleration Gy according to a component of external force (centrifugal force, gravity or the like) exerted on the vehicle detects, as the detected actual lateral acceleration Gy, the acceleration whose absolute value is greater than the absolute value of the actual lateral acceleration (≠0) actually exerted on the vehicle (based upon the centrifugal force due to the turning run), that is running approximately straight, by the amount according to the cant amount CANT in the body roll direction of the road surface. The control device executes predetermined corresponding roll-over preventing process according to a continuation time of a state that the value of the cant amount CANT exceeds a roll-over preventing threshold value CANTref.

### BACKGROUND OF THE INVENTION

1. Field of the Invention

The present invention relates to a control device for a vehicle for preventing a roll angle of a vehicle from being excessive.

2. Description of the Prior Arts

There has conventionally been a demand for controlling a vehicle (its motion) so as to prevent the running state of the vehicle from being unstable due to the occurrence of an excessive roll angle (an inclination angle in a roll direction from a horizontal direction of the vehicle body in this specification) on the vehicle. This roll angle depends upon the value of an actual lateral acceleration (accordingly, the value of the centrifugal force) that is a component of an acceleration actually exerted on the vehicle in the lateral direction of the vehicle body when the vehicle is in the turning state, and increases with the increase of the actual lateral acceleration. On the other hand, the value of the actual lateral acceleration exerted on the vehicle is decreased by producing a yawing moment in the direction opposite to the turning direction of the vehicle or by decelerating the vehicle.

From the above, a control device for a vehicle disclosed in the patent document 1 has a lateral acceleration sensor for detecting an actual lateral acceleration exerted on the vehicle, wherein it executes a control for exerting predetermined braking force on the outer wheel in the turning direction of the vehicle when the actual lateral acceleration (its absolute value) detected by the lateral acceleration sensor exceeds a predetermined roll-over preventing threshold value with the vehicle brought into a turning state. According to this device, a yawing moment is given to the vehicle in the direction opposite to the turning direction of the vehicle due to the predetermined braking force, whereby the value of the actual lateral acceleration exerted on the vehicle is decreased, thereby being capable of preventing the occurrence of the excessive roll angle on the vehicle.

[Patent Document 1]

Japanese Unexamined Patent Application No. HEI10-81215

The disclosed conventional device executes a control on the assumption that the excessive roll angle is caused by the increase of the actual lateral acceleration (accordingly, the centrifugal force) exerted on the vehicle when the vehicle is running as turning on the horizontal (or approximately horizontal) road. In this case, the roll angle becomes excessive only when a relatively great actual lateral acceleration (accordingly, the centrifugal force) is exerted on the vehicle, so that the roll-over preventing threshold value is generally set to a relatively great value.

However, in such a case where the vehicle running on a horizontal road surface gradually deviates, as going approximately straight, toward a shoulder of a road whose height is lower than the horizontal road surface, there may be the case where the roll angle becomes excessive depending upon the shape of the shoulder, but the actual lateral acceleration does highly possibly not exceed the roll-over preventing threshold value since the actual lateral acceleration exerted on the vehicle is kept to be a relatively small value. Accordingly, the control for preventing the occurrence of the excessive roll angle is not started in this case, resulting in that there is a possibility that the roll angle becomes excessive.

In other words, it may sometimes be difficult to prevent the occurrence of the excessive roll angle by the control based upon the value showing the motion state of the vehicle such as the lateral acceleration exerted on the vehicle or the like. Therefore, in order to surely prevent the occurrence of the excessive roll angle, it is necessary to execute a control considering the road surface state, such as the inclination of the road or the like, on which the vehicle runs.

### SUMMARY OF THE INVENTION

The present invention aims to provide a control device for a vehicle that can surely prevent a roll angle of a vehicle from being excessive by considering a state of a road on which the vehicle runs.

A control device for a vehicle according to the present invention comprises road surface obtaining means for obtaining a value according to a height difference in the vertical direction on a road surface, on which a vehicle runs, between a contact position of wheels at the left side of the body and a contact position of wheels at the right side of the body, and specific process executing means for executing a specific process for preventing a roll angle of the vehicle from being excessive when the obtained value according to the height difference becomes a value showing that the height difference is greater than a predetermined value. In this case, it is preferable that the road surface obtaining means is configured to obtain a value showing a degree of inclination of the road surface, on which the vehicle runs, in the body roll direction as the value according to the height difference.

According to this configuration, the specific process can be started and executed for preventing that the roll angle of the vehicle becomes excessive by considering the value (for example, an inclination (cant) amount (inclination angle) of the road in the body roll direction) according to the height difference between the contact position of the wheels at the left side of the vehicle body and the contact position of the wheels at the right side of the vehicle body in the vertical direction on the road on which the vehicle runs, i.e., by considering the state of the road surface. Therefore, the roll angle being excessive can surely be prevented even in the case where the roll angle can be excessive with the actual lateral acceleration exerted on the vehicle (based on the centrifugal force due to the turning run) kept to be relatively small value, such as the case where the vehicle gradually deviates toward a shoulder of a road.

In the control device for a vehicle mentioned above, it is preferable that the road surface state obtaining means is provided with motion state quantity obtaining means for obtaining motion state quantity showing a motion state of the vehicle, estimated lateral acceleration calculating means for calculating, as an estimated lateral acceleration, an estimated value of a lateral acceleration that is a component of the acceleration exerted on the vehicle in the lateral direction of the vehicle body, based upon the obtained motion state quantity and a lateral acceleration sensor for obtaining the actual value of the lateral acceleration as an actual lateral acceleration by detecting the value of the component of external force exerted on the vehicle in the lateral direction of the vehicle body, and the road surface state obtaining means is configured to obtain the value according to the height difference based upon the result of the comparison between the calculated estimated lateral acceleration and the obtained actual lateral acceleration.

The estimated lateral acceleration calculated based upon the motion state quantity (for example, wheel speed of each wheel) showing the motion state of the vehicle can be the same value (or approximately same value) as the actual lateral acceleration actually exerted on the vehicle regardless of the road surface state (whether the above-mentioned height difference is great or not). On the other hand, the output from the lateral acceleration sensor configured to obtain the actual lateral acceleration actually exerted on the vehicle by detecting the value of the component of external force (gravity, centrifugal force, or the like) exerted on the vehicle in the lateral direction of the vehicle body depends upon the road surface state (whether the above-mentioned height difference is great or not).

More specifically, if there is a height difference between the contact position of the wheels at the left side of the vehicle body and the contact position of the wheels at the right side of the vehicle body in the vertical direction on the road surface on which the vehicle runs, the vehicle body is inclined in the body roll direction according to the height difference (i.e., the roll angle according to the height difference occurs even if the vehicle is halted). If so, the component of gravity exerted on the vehicle in the lateral direction of the vehicle body is produced according to the height difference, whereby the influence of the component of the gravity in the lateral direction of the vehicle body caused according to the height difference appears as the output of the lateral acceleration sensor having the above-mentioned configuration. Therefore, the value of the actual lateral acceleration (detected actual lateral acceleration) corresponding to the output from the lateral acceleration sensor differs, according to the height difference, from the value of the actual lateral acceleration (accordingly, the estimated lateral acceleration) actually exerted on the vehicle (based on the centrifugal force due to the turning run). In other words, in case where the height difference is generated such as the case that the vehicle gradually deviates toward the shoulder of the road, the result of the comparison (for example, difference, ratio or the like) between the estimated lateral acceleration and the detected actual lateral acceleration represents the degree of the height difference.

The above-mentioned configuration is accomplished based upon this knowledge. As described above, the estimated lateral acceleration calculated by the estimated lateral acceleration calculating means based upon the motion state quantity (for example, wheel speed of each wheel) and the actual lateral acceleration (detected actual lateral acceleration) obtained by the lateral acceleration sensor having the above-mentioned configuration are compared to each other, whereby the value according to the height difference can simply and correctly be obtained based upon the result of the comparison.

In this case, it is preferable that the motion state quantity obtaining means is configured so as to obtain the wheel speed of each wheel of the vehicle as the motion state quantity, and the estimated lateral acceleration calculating means is configured to calculate the estimated lateral acceleration based upon the difference between the wheel speed of the wheels at the left side of the vehicle body and the wheel speed of the wheels at the right side of the vehicle body. The difference between the wheel speed of the wheels at the left side of the vehicle body and the wheel speed of the wheels at the right side of the vehicle body means here the difference between the wheel speed of the front-left wheel (or rear-left wheel) and the wheel speed of the front-right wheel (or rear-right wheel), the difference between the average of the wheel speeds of the front-left and rear-left wheels and the average of the wheel speeds of the front-right and rear-right wheels, the difference between the wheel speed of the front-left wheel and the wheel speed of the rear-right wheel, the difference between the wheel speed of the front-right wheel and the wheel speed of the rear-left wheel, or the like.

The difference between the wheel speed of the wheels at the left side of the vehicle body and the wheel speed of the wheels at the right side of the vehicle body can be a value precisely showing a degree (yaw rate or the like) of a turn of the vehicle regardless of the road surface state (whether the height difference is great or not). Further, the actual lateral acceleration actually exerted on the vehicle changes according to the degree (yaw rate or the like) of the turn of the vehicle. Accordingly, the above-mentioned configuration in which the estimated lateral acceleration is calculated based upon the difference between the wheel speed of the wheels at the left side of the vehicle body and the wheel speed of the wheels at the right side of the vehicle body can calculate the actual lateral acceleration actually exerted on the vehicle with enhanced precision without using an expensive sensor such as a yaw rate sensor for detecting the value showing the degree of the turn of the vehicle.

Moreover, in any one of the control devices mentioned above, it is preferable that the specific process executing means is configured to execute at least one of a process for producing an alarm and a process for decelerating the vehicle. The process for decelerating the vehicle includes here a process for producing braking force on the wheels of the vehicle by a brake fluid pressure regardless of the operation of the brake pedal by the driver or a process for reducing a power from a power source (for example, internal combustion engine) of the vehicle.

When the process for producing an alarm is executed as the specific process, for preventing the roll angle of the vehicle from being excessive, executed when the value according to the height difference becomes a value showing that the height difference is greater than a predetermined value (for example, when the cant amount of the road surface in the body roll direction becomes a value greater than a predetermined value), the driver can be told that the height difference is great (for example, the cant amount is great). As a result, the device promotes the driver to do an operation for decreasing the roll angle of the vehicle (for example, promotes the driver to operate the steering so as to run the vehicle on the road having a small cant amount), thereby being capable of preventing the roll angle of the vehicle from being excessive.

Further, when the process for decelerating the vehicle is executed as the specific process, the vehicle body speed is decreased, so that any time is given to the driver upon executing an operation for decreasing the roll angle, with the result that the roll angle of the vehicle can surely be prevented from being excessive.

### BRIEF DESCRIPTION OF THE DRAWINGS

FIG. 1 is a schematic constructional view of a vehicle having mounted thereto a control device for a vehicle according to an embodiment of the present invention;

FIG. 2 is a schematic constructional view of a brake hydraulic control device shown in FIG. 1;

FIG. 3 is a schematic constructional view of a lateral acceleration sensor shown in FIG. 1;

FIG. 4 is a time chart showing a change of a detected actual lateral acceleration Gy detected by a lateral acceleration sensor, an estimated lateral acceleration Gyest and a cant amount CANT in case where the vehicle running on the horizontal asphalt road is gradually deviated, as going approximately straight, toward the right shoulder whose height is lower than the asphalt road;

FIG. 5 is a flowchart showing a routine executed by a CPU shown in FIG. 1 for controlling an opening of a throttle valve;

FIG. 6 is a flowchart executed by the CPU shown in FIG. 1 for calculating a wheel speed or the like;

FIG. 7 is a flowchart executed by the CPU shown in FIG. 1 for calculating a lateral acceleration deviation;

FIG. 8 is a flowchart executed by the CPU shown in FIG. 1 for calculating a target slip ratio;

FIG. 9 is a flowchart showing a routine executed by the CPU shown in FIG. 1 for setting a control mode;

FIG. 10 is a flowchart showing a routine executed by the CPU shown in FIG. 1 for controlling braking force exerted on each wheel; and

FIG. 11 is a flowchart showing a routine executed by the CPU shown in FIG. 1 for performing a judge of a start of a roll-over preventing process.

### DESCRIPTION OF THE PREFERRED EMBODIMENT

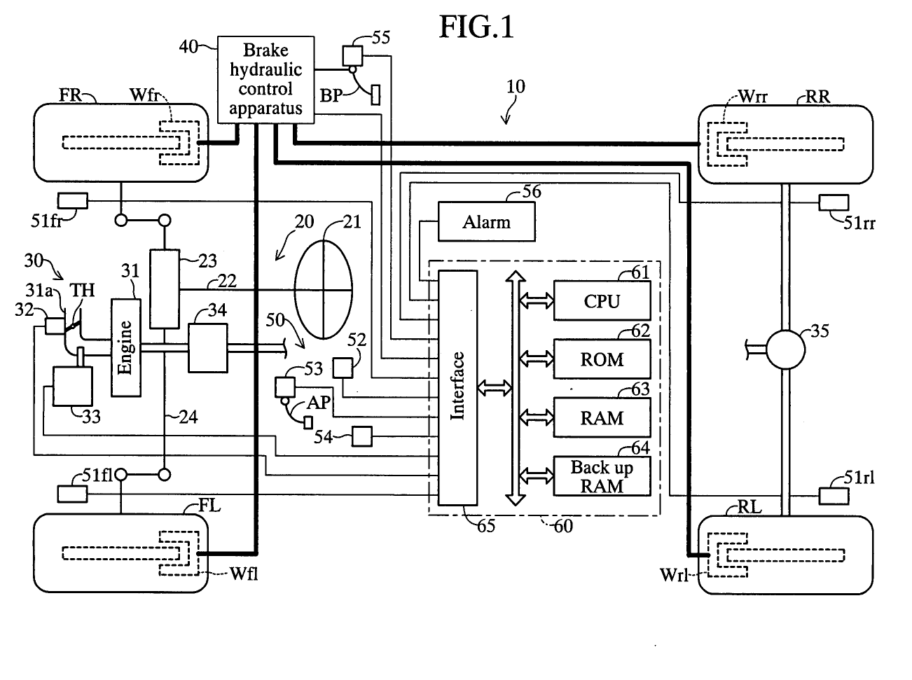

A preferred embodiment of a control device for a vehicle according to the present invention will be explained hereinbelow with reference to drawings. FIG. 1 shows a schematic construction of a vehicle provided with a control device 10 for a vehicle according to the embodiment of the invention. This vehicle is a four-wheel drive vehicle using a rear-wheel drive system and having two front wheels (front-left wheel FL and front-right wheel FR) that are steering wheels as well as non-driving wheels and two rear wheels (rear-left wheel RL and rear-right wheel RR) that are driving wheels.

The control device 10 for the vehicle is configured to include a front-wheel steering mechanism 20 for steering the steering wheels FL and FR, a driving force transmission section 30 that produces driving force and respectively transmits this driving force to each driving wheel RL and RR, a brake hydraulic control apparatus 40 for producing braking force by a brake fluid pressure on each wheel, a sensor section 50 composed of various sensors and an electrical control apparatus 60.

The front-wheel steering mechanism 20 is composed of a steering 21, column 22 integrally pivotable with the steering 21, steering actuator 23 linked to the column 22 and a link mechanism 24 including a tie rod that is moved in the lateral direction of the vehicle body by the steering actuator 23 and a link that can steer the steering wheels FL and FR by the movement of the tie rod. By this configuration, rotating the steering 21 from its center position (reference position) changes the steering angles of the steering wheels FL and FR from the reference angle at which the vehicle runs straight.

The steering actuator 23 is composed to include a known so-called hydraulic power steering device that generates assisting force for moving the tie rod according to the rotational torque of the column 22, thereby shifting the tie rod from the neutral position to the lateral direction of the vehicle by the assisting force in proportion to the steering angle θs from the neutral position of the steering 21. The configuration and operation of the steering actuator 23 are well known, so that the detailed explanation thereof is omitted here.

The driving force transmission section 30 is configured to include an engine 31 that produces driving force, a throttle valve actuator 32 arranged in an inlet pipe 31 a of the engine 31 and having a DC motor for controlling an opening TA of a throttle valve TH that can modulate the cross-sectional area of the inlet path, a fuel injection device 33 including an injector that injects fuel to the vicinity of an inlet port not shown of the engine 31, a transmission 34 connected to the output shaft of the engine 31 and a differential gear 36 that suitably distributes and transmits the driving force transmitted from the transmission 34 to rear wheels RR and RL.

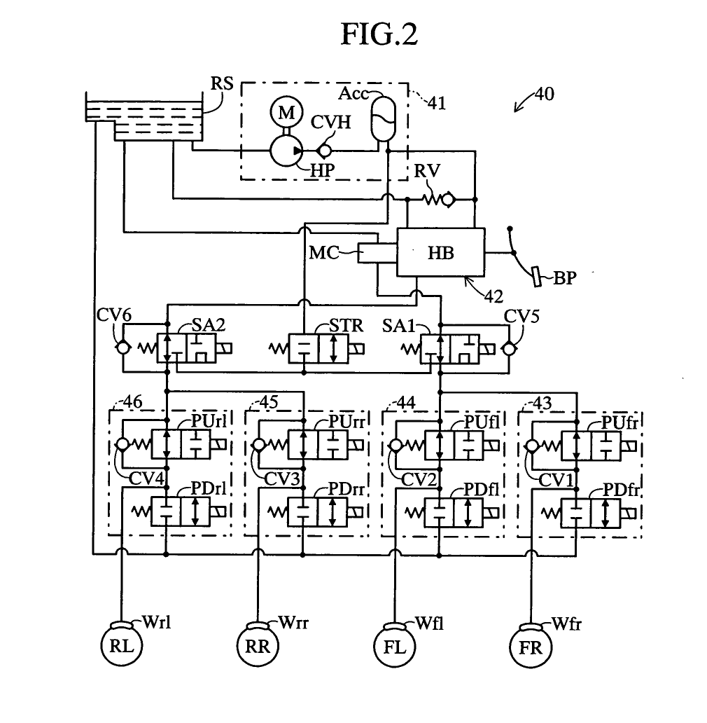

The brake hydraulic control apparatus 40 whose construction is schematically shown in FIG. 2 is configured to include a high-pressure generating section 41, a brake fluid pressure generating section 42 that generates brake fluid pressure according to operating force on a brake pedal BP, and an FR brake fluid pressure adjusting section 43, an FL brake fluid pressure adjusting section 44, an RR brake fluid pressure adjusting section 45 and an RL brake fluid pressure adjusting section 46 that are capable of adjusting brake fluid pressure supplied respectively to wheel cylinders Wfr, Wfl, Wrr and Wrl each arranged at each wheel FR, FL, RR and RL.

The high-pressure generating section 41 is configured to include an electric motor M, a hydraulic pump HP driven by the electric motor M and pressurizing brake fluid in a reservoir RS and an accumulator Acc that is connected to the discharge side of the hydraulic pump HP via a check valve CVH and stores brake fluid pressurized by the hydraulic pump HP.

The electric motor M is driven when the fluid pressure in the accumulator Acc is less than a predetermined lower limit value, while it is halted when the fluid pressure in the accumulator Acc exceeds a predetermined upper limit value. By this, the fluid pressure in the accumulator Acc is always kept high within a predetermined range.

A relief valve RV is arranged between the accumulator Acc and the reservoir RS. When the fluid pressure in the accumulator Acc becomes extraordinarily higher than the above-mentioned high pressure, the brake fluid in the accumulator Acc is returned to the reservoir RS. This operation protects a hydraulic circuit in the high-pressure generating section 41.

The brake hydraulic generating section 42 is composed of a hydraulic booster HB that is driven according to the operation of the brake pedal BP and a master cylinder MC connected to the hydraulic booster HB. The hydraulic booster HB assists the operating force on the brake pedal BP at a predetermined ratio by utilizing the above-mentioned high pressure supplied from the high-pressure generating section 41 and transmits the assisted operating force to the master cylinder MC.

The master cylinder MC generates master cylinder fluid pressure according to the assisted operating force. Further, the hydraulic booster HB, by inputting this master cylinder fluid pressure, generates regulator fluid pressure that is approximately equal to the master cylinder fluid pressure according to the assisted operating force. The constructions and operations of the master cylinder MC and hydraulic booster HB are well known, so that their detailed explanations are omitted here. As described above, the master cylinder MC and hydraulic booster HB respectively generate master cylinder fluid pressure and regulator fluid pressure according to the operating force on the brake pedal BP.

A control valve SA1 that is a three-port two-position switching type solenoid-operated valve is arranged between the master cylinder MC and each of the upstream side of the FR brake fluid pressure adjusting section 43 and the upstream side of the FL brake fluid pressure adjusting section 44. Similarly, a control valve SA2 that is a three-port two-position switching type solenoid-operated valve is arranged between the hydraulic booster HB and each of the upstream side of the RR brake fluid pressure adjusting section 45 and the upstream side of the RL brake fluid pressure adjusting section 46. Further, a change-over valve STR that is a two-port two-position switching type, normally closed, solenoid-operated on-off valve is arranged between the high-pressure generating section 41 and each of the control valve SA1 and the control valve SA2.

When the control valve SA1 is in the first position in FIG. 2 (in the non-actuated position), it functions to establish communication between the master cylinder MC and each of the upstream section of the FR brake fluid pressure adjusting section 43 and the upstream section of the FL brake fluid pressure adjusting section 44. When in the second position (in the actuated position), it functions to cut off the communication between the master cylinder MC and each of the upstream section of the FR brake fluid pressure adjusting section 43 and the upstream section of the FL brake fluid pressure adjusting section 44, but to establish the communication between the change-over valve STR and each of the upstream section of the FR brake fluid pressure adjusting section 43 and the upstream section of the FL brake fluid pressure adjusting section 44.

When the control valve SA2 is in the first position in FIG. 2 (in the non-actuated position), it functions to establish communication between the hydraulic booster HB and each of the upstream section of the RR brake fluid pressure adjusting section 45 and the upstream section of the RL brake fluid pressure adjusting section 46. When in the second position (in the actuated position), it functions to cut off the communication between the hydraulic booster HB and each of the upstream section of the RR brake fluid pressure adjusting section 45 and the upstream section of the RL brake fluid pressure adjusting section 46, but to establish the communication between the change-over valve STR and each of the upstream section of the RR brake fluid pressure adjusting section 45 and the upstream section of the RL brake fluid pressure adjusting section 46.

By this operation, master cylinder fluid pressure is supplied to each of the upstream section of the FR brake fluid pressure adjusting section 43 and the upstream section of the FL brake fluid pressure adjusting section 44 when the control valve SA1 is placed at the first position, while high pressure generated from the high-pressure generating section 41 is supplied thereto when the control valve SA1 is placed at the second position and the change-over valve STR is placed at the second position (at the actuated position).

Similarly, regulator fluid pressure is supplied to each of the upstream section of the RR brake fluid pressure adjusting section 45 and the upstream section of the RL brake fluid pressure adjusting section 46 when the control valve SA2 is placed at the first position, while high pressure generated from the high-pressure generating section 41 is supplied thereto when the control valve SA2 is placed at the second position and the change-over valve STR is placed at the second position.

The FR brake fluid pressure adjusting section 43 is composed of a pressure increasing valve PUfr that is a two-port two-position switching type, normally opened, solenoid-operated on-off valve and a pressure reducing valve PDfr that is a two-port two-position switching type, normally closed, solenoid-operated on-off valve. The pressure increasing valve PUfr, when placed at the first position in FIG. 2 (at the non-actuated position), establishes a communication between the upstream section of the FR brake fluid pressure adjusting section 43 and the wheel cylinder Wfr, while it cuts off the communication between the upstream section of the FR brake fluid pressure adjusting section 43 and the wheel cylinder Wfr when placed at the second position (at the actuated position). The pressure reducing valve PDfr cuts off the communication between the wheel cylinder Wfr and the reservoir RS when it is placed at the first position in FIG. 2 (at the non-actuated position), while it establishes the communication between the wheel cylinder Wfr and the reservoir RS when placed at the second position (at the actuated position).

By this operation, the brake fluid pressure in the wheel cylinder Wfr is increased when the pressure increasing valve PUfr and the pressure reducing valve PDfr are placed at the first position since the fluid pressure at the upstream section of the FR brake fluid pressure adjusting section 43 is supplied into the wheel cylinder Wfr. When the pressure increasing valve PUfr is placed at the second position and the pressure reducing valve PDfr is placed at the first position, the brake fluid pressure in the wheel cylinder Wfr is kept to be the fluid pressure at the time in the wheel cylinder Wfr regardless of the fluid pressure at the upstream section of the FR brake fluid pressure adjusting section 43. When the pressure increasing valve PUfr and the pressure reducing valve PDfr are placed at the second position, the brake fluid in the wheel cylinder Wfr is returned to the reservoir RS to thereby reduce the fluid pressure.

A check valve CV1 is arranged in parallel to the pressure increasing valve PUfr for allowing only one-way flow of the brake fluid from the wheel cylinder Wfr side to the upstream section of the FR brake fluid pressure adjusting section 43. This arrangement brings a rapid reduction of the brake fluid pressure in the wheel cylinder Wfr when the released brake pedal BP is opened with the control valve SA1 placed at the first position.

Similarly, the FL brake fluid pressure adjusting section 44, RR brake fluid pressure adjusting section 45 and RL brake fluid pressure adjusting section 46 are respectively composed of a pressure increasing valve PUfl and pressure reducing valve PDfl, a pressure increasing valve PUrr and pressure reducing valve PDrr and a pressure increasing valve PUrl and pressure reducing valve PDrl. The position of each pressure increasing valve and pressure reducing valve is controlled, whereby the brake fluid pressure in the wheel cylinder Wfl, wheel cylinder Wrr and wheel cylinder Wrl can be increased, kept and reduced. Further, check valves CV2, CV3 and CV4 that can attain the function same as that of the check valve CV1 are respectively arranged in parallel to the pressure increasing valves PUfl, PUrr and PUrl.

A check valve CV5 is arranged in parallel to the control valve SA1 for allowing only one-way flow of the brake fluid from the upstream side to the downstream side. When the control valve SA1 is placed at the second position and the communication between the master cylinder MC and each of the FR brake fluid pressure adjusting section 43 and the FL brake fluid pressure adjusting section 44 is cut off, the brake fluid pressure in the wheel cylinders Wfr and Wfl can be increased by operating the brake pedal BP. Further, arranged in parallel to the control valve SA2 is a check valve CV6 that can attain the function same as that of the check valve CV5.

By the construction described above, the brake hydraulic control apparatus 40 can supply brake fluid pressure according to the operating force on the brake pedal BP to each wheel cylinder when all the solenoid-operated valves are in the first position. Further, under this state, it can reduce, for example, only the brake fluid pressure in the wheel cylinder Wrr by a predetermined amount by controlling the pressure increasing valve PUrr and pressure reducing valve PDrr.

By changing the control valve SA1, change-over valve STR and pressure increasing valve PUfl to the second position and controlling the pressure increasing valve PUfr and pressure reducing valve PDfr respectively, the brake hydraulic control apparatus 40 can increase only the brake fluid pressure in the wheel cylinder Wfr by a predetermined value by utilizing the high pressure generated from the high-pressure generating section 41 while the brake fluid pressure in the wheel cylinder Wfl is maintained under a state where the brake pedal BP is not operated (is released). As described above, the brake hydraulic control apparatus 40 independently controls the brake fluid pressure in the wheel cylinder of each wheel regardless of the operation on the brake pedal BP, thereby being capable of exerting predetermined braking force on every independent wheel.

Referring again to FIG. 1, the sensor section 50 is composed of wheel speed sensors 51fl, 51fr, 51rl and 51rr as motion state quantity obtaining means each constructed by a rotary encoder that outputs a signal having a pulse every time each wheel FL, FR, RL and RR rotates at a predetermined angle, a steering angle sensor 52, serving as steering operating amount obtaining means, for detecting the angle of rotation from the neutral position of the steering 21 to output a signal showing a steering angle θs, an accelerator opening sensor 53 that detects an operating amount of an accelerator pedal AP operated by a driver and outputs a signal showing the operating amount Accp of the accelerator pedal AP, a lateral acceleration sensor 54 that detects an actual lateral acceleration which is a component in the lateral direction of a vehicle body of the acceleration actually exerted on the vehicle and outputs a signal Va showing the (detected) actual lateral acceleration Gy (m/s²) and a brake switch 55 that detects whether the brake pedal BP is operated or not by the driver for outputting a signal showing that the braking operation is performed or not.

The steering angle θs detected by the steering angle sensor 52 is set to be “0” when the steering 21 is positioned at the neutral position, set to a positive value when the steering 21 is rotated in the counterclockwise direction (seen by a driver) from the neutral position, and set to a negative value when the steering 21 is rotated in the clockwise direction from the neutral position.

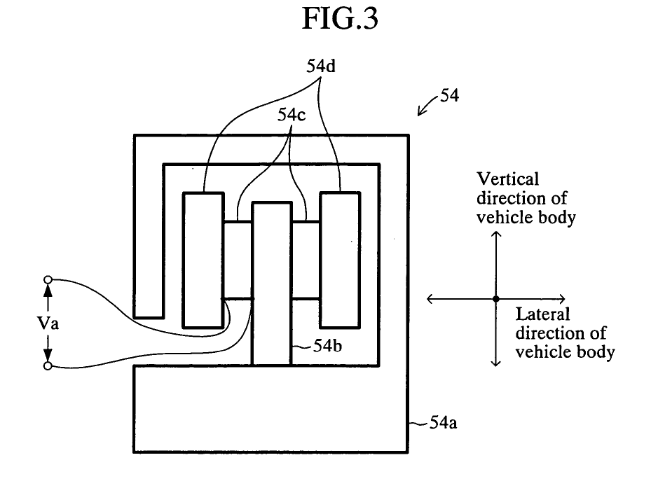

The lateral acceleration sensor 54, the schematic construction of which is shown in FIG. 3, is composed of a base section 54a fixed to the vehicle body in the vicinity of the center of gravity of the vehicle and having a space inside, a rising member 54b that is disposed to rise toward the upward (vertical) direction of the vehicle body from the base section 54a along the longitudinal direction of the vehicle body in the space of the base section 54a and has an approximately rectangular shape and dead weights 54d, 54d connected respectively to each face of the rising member 54b facing toward the side direction of the vehicle body via ceramic piezoelectric elements 54c, 54c.

The ceramic piezoelectric elements 54c, 54c generate a voltage (potential difference) Va according to a strain of the ceramic piezoelectric elements 54c, 54c in the lateral direction of the body that is produced according to a component value of external force (centrifugal force, gravity or the like) exerted on the dead weights 54d, 54d (accordingly, on the vehicle) in the lateral direction of the body. Therefore, the lateral acceleration sensor 54 can detect, as the detected actual lateral acceleration Gy, the lateral acceleration according to the centrifugal force generated on the vehicle when the vehicle turns based on the voltage (signal) Va.

Further, when the vehicle body is inclined in the roll direction since the vehicle runs on the road surface that is inclined in the body roll direction (when the roll angle is not “0”), the component of the gravity exerted on the dead weights 54d, 54d (accordingly, on the vehicle) in the lateral direction of the body is generated according to a value (hereinafter referred to as “cant amount CANT”) according to a height difference in the vertical direction between the contact position on the road of the wheels at the left side of the body and the contact position on the road of the wheels at the right side of the body, whereby the voltage Va generated by the lateral acceleration sensor 54 varies with the cant amount CANT. As a result, the lateral acceleration sensor 54 detects, as the detected actual lateral acceleration Gy, an acceleration that is different from the actual lateral acceleration and is actually generated on the vehicle (based upon the centrifugal force by the turning run) by the amount according to the cant amount CANT.

The detected actual lateral acceleration Gy is set to be a positive value when the external force in the rightward direction of the body is exerted on the dead weights 54d, 54d (accordingly, on the vehicle), i.e., when the centrifugal force is exerted in the rightward direction of the body due to the leftward turn of the vehicle or when the vehicle body is inclined (rolled) in the rightward direction of the body due to the inclination of the road surface, while it is set to be a negative value when the external force in the leftward direction of the body is exerted on the dead weights 54d, 54d (accordingly, on the vehicle), i.e., when the centrifugal force is exerted in the leftward direction of the body due to the rightward turn of the vehicle or when the vehicle body is inclined (rolled) in the leftward direction of the body due to the inclination of the road surface.

The electrical control apparatus 60 is a microcomputer including a CPU 61, a ROM 62 that stores in advance a routine (program) executed by the CPU 61, table (look-up table, map), constant or the like, a RAM 63 to which the CPU 61 temporarily stores data as needed, a back-up RAM 64 that stores data with a power supply turned on and holds the stored data even during a period when the power supply is turned off and an interface 65 including an AD converter, those of which are connected to one another with a bus. The interface 65 is connected to the sensors 51 to 55, thereby supplying to the CPU 61 signals from the sensors 51 to 55 and transmitting a driving signal to each solenoid-operated valve and motor M of the brake hydraulic control apparatus 40, the throttle valve actuator 32 and the fuel injection device 33 according to the instruction from the CPU 61. Moreover, the interface 65 transmits to an alarm 56, according to the instruction from the CPU 61, an alarm indication signal for causing the alarm 56 to produce an alarm for informing the user that there is a high possibility of vehicle roll-over.

By this operation, the throttle valve actuator 32 drives the throttle valve TH such that the opening TA thereof becomes a target throttle valve opening TAt that is set according to the operating amount Accp of the accelerator pedal AP, and the fuel injection device 33 injects fuel in a required amount so as to obtain a predetermined target air-fuel ratio (theoretical air-fuel ratio) concerning intake air mass according to the opening of the throttle valve TH.

[Outline of Motion Control of a Vehicle]

The control device 10 (simply referred sometimes to as “this device” hereinbelow) for a vehicle calculates the target lateral acceleration Gyt (m/s²) based upon a following formula 1 that is a theoretical formula as a predetermined rule directed from a vehicle motion model. The target lateral acceleration Gyt is set to the positive value when the vehicle turns in the leftward direction (when the steering angle θs (deg) is a positive value), while it is set to the negative value when the vehicle turns in the rightward direction (when the steering angle θs is a negative value). This theoretical formula is a formula for calculating a theoretical value of the lateral acceleration exerted on the vehicle when the vehicle turns with the steering angle and vehicle body speed constant (upon the normal circular turn).

Gyt=(Vso²θs)/(n·1)·(1/(1+Kh·Vso²)) [Formula 1]

In the above formula 1, Vso is a calculated estimated body speed (m/s) as described later. Further, n is a gear ratio (constant value) that is a ratio of a change amount of a rotation angle of the steering 21 to a change amount of a turning angle of the steering wheels FL and FR, I is a wheel base (m) of the vehicle that is a constant value determined by the vehicle body, and Kh is a stability factor (s²/m²) that is a constant value determined by the vehicle body.

Further, this device also calculates a lateral acceleration deviation ΔGy (m/s²), based upon the formula 2 described later, that is a deviation between the absolute value of the target lateral acceleration Gyt calculated as described above and the absolute value of the detected actual lateral acceleration Gy obtained by the lateral acceleration sensor 54.

ΔGy=|Gyt|−|Gy| [Formula 2]

When the value of the lateral acceleration deviation ΔGy is a positive value, the vehicle is in a state where the turning radius is greater than the turning radius of when the target lateral acceleration Gyt is assumed to be caused on the vehicle (hereinafter referred to as “understeer state”), whereby this device executes an understeer suppressing control for suppressing the understeer state. Specifically, this device exerts predetermined braking force on the rear wheel at the inner side of the turning direction according to the lateral acceleration deviation ΔGy, thereby forcibly producing a yawing moment with respect to the vehicle in the direction same as the turning direction. This allows to increase the absolute value of the detected actual lateral acceleration Gy, so that the detected actual lateral acceleration Gy is controlled to be close to the target lateral acceleration Gyt.

Moreover, when the value of the lateral acceleration deviation ΔGy is a negative value, the vehicle is in a state where the turning radius is smaller than the turning radius of when the target lateral acceleration Gyt is assumed to be caused on the vehicle (hereinafter referred to as “oversteer state”), whereby this device executes an oversteer suppressing control for suppressing the oversteer state. Specifically, this device exerts predetermined braking force on the front wheel at the outer side of the turning direction according to the lateral acceleration deviation ΔGy, thereby forcibly producing a yawing moment with respect to the vehicle in the direction opposite to the turning direction. This allows to decrease the absolute value of the detected actual lateral acceleration Gy, so that the detected actual lateral acceleration Gy is controlled to be close to the target lateral acceleration Gyt.

As described above, the understeer suppressing control or the oversteer suppressing control (hereinafter generically referred to as “brake steering control”) is executed, whereby this device controls the braking force that should be exerted on each wheel, thereby causing a predetermined yawing moment to the vehicle in the direction where the detected actual lateral acceleration Gy (accordingly, the lateral acceleration based upon the centrifugal force produced on the vehicle upon the turning run) gets close to the target lateral acceleration Gyt calculated as described above. Further, when any one of an anti-skid control, front-rear braking force distribution control and traction control described later is also required to be executed upon executing the brake steering control, this device finally determines the braking force that should be exerted on each wheel by considering also the braking force that should be exerted on each wheel for executing any one of the above-mentioned controls. The above description is about the outline of the motion control of the vehicle.

[Process for Preventing Roll-over)

When the height difference in the vertical direction between the contact position of the wheels at the left side of the vehicle body and the contact position of the wheels at the right side of the vehicle body on the road surface on which the vehicle runs becomes great (i.e., when the absolute value of the cant amount CANT becomes great) such as the case where the vehicle running on a horizontal road surface gradually deviates, as going approximately straight, toward a shoulder of a road whose height is lower than the horizontal road surface, the roll angle of the vehicle is liable to be excessive, so that it is necessary to prevent the roll angle from being excessive.

As previously explained, the road on which the vehicle is running approximately straight is inclined in the body roll direction (accordingly, when the cant amount CANT is not “0”), the lateral acceleration sensor 54 detects, as the detected actual lateral acceleration Gy, the acceleration whose absolute value is greater than the absolute value of the actual lateral acceleration (=0) that is actually caused on the vehicle (based upon the centrifugal force due to the turning run) by the amount according to the cant amount CANT. Accordingly, the difference between the actual lateral acceleration that is actually caused on the vehicle (based upon the centrifugal force due to the turning run) and the detected actual lateral acceleration Gy by the lateral acceleration sensor 54 is a value showing the cant amount CANT.

Further, the actual lateral acceleration actually caused on the vehicle (based upon the centrifugal force due to the turning run) can correctly be estimated based upon the difference between the wheel speed of the wheel at the left side of the vehicle body and the wheel speed of the wheels at the right side of the vehicle body when each wheel is not slipped. Specifically, the estimated lateral acceleration Gyest (m/s²) can be calculated according to a formula 3 described later from a difference between the average value Vwlave of the wheel speed Vwfl of the front-left wheel FL and the wheel speed Vwrl of the rear-left wheel RL that are the wheel speeds of the wheels at the left side of the vehicle body obtained from the wheel speed sensors 51fl and 51 rl as described later and the average value Vwrave of the wheel speed Vwfr of the front-right wheel FR and the wheel speed Vwrr of the rear-right wheel RR that are the wheel speeds of the wheels at the right side of the vehicle body obtained from the wheel speed sensors 51fr and 51rr as described later, the estimated body speed Vso and the value of the wheel tread T(m) that is a distance between the center lines in the lateral direction of the vehicle body on the contact surface of the tire tread of the left and right wheels (e.g., rear-left and rear-right wheels RL, RR) with the road surface. Note that this estimated lateral acceleration Gyest is calculated so as to become a positive value when the vehicle turns in the leftward direction while become a negative value when the vehicle turns in the rightward direction like the detected actual lateral acceleration Gy detected by the lateral acceleration sensor 54, as understood from the formula 3 described later. The means for calculating the estimated lateral acceleration corresponds to estimated acceleration calculating means.

Gyest=(Vwrave−Vwlave)·Vso/T [Formula 3]

This device calculates the cant amount CANT according to a formula 4 described later by subtracting the estimated acceleration Gyest calculated from the formula 3 from the detected actual lateral acceleration Gy detected by the lateral acceleration sensor 54. The means for calculating the cant amount CANT that is a value according to the height difference corresponds to road state obtaining means.

CANT=Gy−Gyest [Formula 4]

This device determines that the vehicle is in a state where there is a high possibility of roll-over when the absolute value of the detected actual lateral acceleration Gy is greater than the absolute value of the estimated lateral acceleration Gyest and the absolute value of the cant amount CANT calculated according to the formula 4 is greater than the absolute value of a roll-over preventing threshold value CANTref. The reason of addition of the condition in which the absolute value of the detected actual lateral acceleration Gy is greater than the absolute value of the estimated lateral acceleration Gyest is as follows. Specifically, when the absolute value of the estimated lateral acceleration Gyest is greater than the detected actual lateral acceleration Gy, the absolute value of the cant amount CANT becomes greater than the absolute value of the roll-over preventing threshold value CANTref, thereby preventing the misjudge that the vehicle is in the state where there is a high possibility of the roll-over.

Specifically, when any of the wheels is slipped, the estimated lateral acceleration Gyest (its absolute value) may sometimes be erroneously calculated as a great value. In this case, there is a possibility that the cant amount CANT (its absolute value) calculated according to the formula 4 is calculated to be greater than the roll-over preventing threshold value CANTref, regardless of the fact that the actual cant amount (its absolute value) of the road is small and therefore the vehicle is in a state where there is low possibility of the roll-over. In order to prevent this, the condition is added in which the absolute value of the detected actual lateral acceleration Gy is greater than the absolute value of the estimated lateral acceleration Gyest.

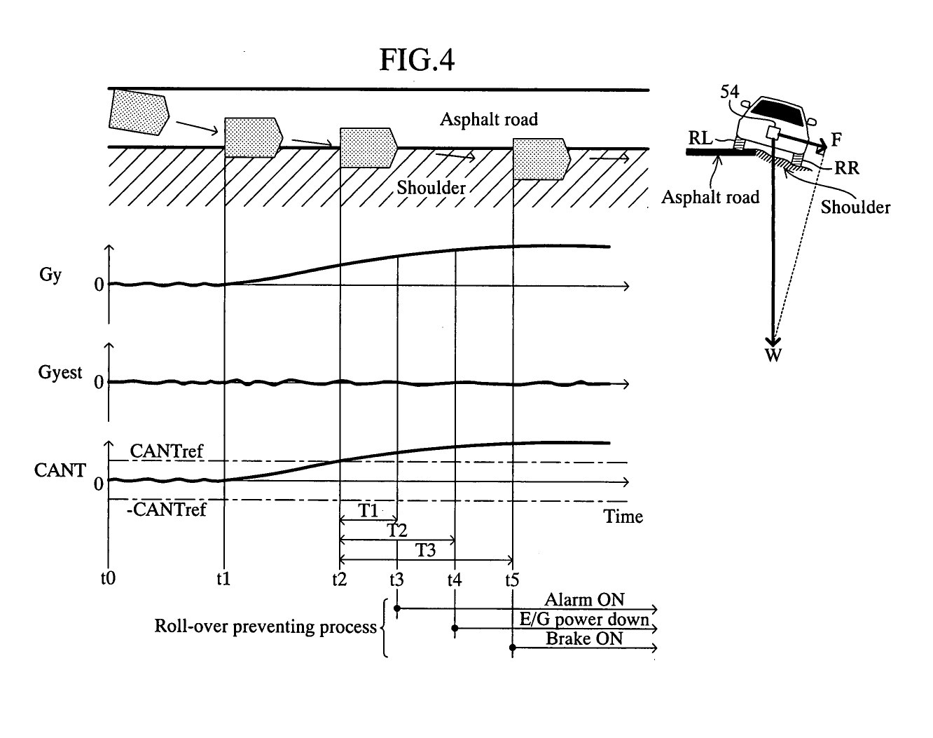

This device executes a roll-over preventing process after it judges that the vehicle is in a state where there is a high possibility of roll-over. This roll-over preventing process differs depending upon the time when the state where the vehicle is judged to be in the state of having high possibility of roll-over continues. More specific explanation will be made hereinbelow with reference to a time chart shown in FIG. 4. FIG. 4 is a time chart showing a change of the detected actual lateral acceleration Gy detected by the lateral acceleration sensor 54, the estimated lateral acceleration Gyest calculated from the formula 3 and the cant amount CANT calculated from the formula 4 in case where the vehicle running on the horizontal asphalt road is gradually deviated, as going approximately straight, toward the right shoulder whose height is lower than the asphalt road.

In FIG. 4, it is assumed that the vehicle keeps on going approximately straight during the period from a time t0 to a time t5 and the steering angle θs is kept to be approximately “0”. The difference between the wheel speed Vwrave of the wheels at the right side of the vehicle body and the wheel speed Vwlave of the wheels at the left side of the vehicle body is kept to be approximately “0” during the period from the time t0 to the time t5. Accordingly, the estimated lateral acceleration Gyest (and the actual lateral acceleration actually exerted on the vehicle (based upon the centrifugal force due to the turning run)) calculated from the formula 3 is always kept to be approximately “0” during this period as shown in FIG. 4.

On the other hand, during the period from the time t0 to a time t1, all four wheels are on the asphalt road, so that the height difference in the vertical direction between the contact position of the left-side wheels and the contact position of the right-side wheels on the road surface on which the vehicle is running becomes “0” (the roll angle is “0”). Therefore, the component of the gravity exerted on the vehicle in the lateral direction of the vehicle body (and the centrifugal force exerted on the vehicle) is “0”, whereby the detected actual lateral acceleration Gy detected by the lateral acceleration sensor 54 is kept to be approximately “0”. Consequently, the cant amount CANT calculated according to the formula 4 is kept to be approximately “0” during the period from the time t0 to the time t1.

At the time t1, only the right-side wheels FR, RR of the vehicle start to deviate toward the right-side shoulder from the asphalt road, thereby causing the height difference. This causes the vehicle body to start to incline to the right, thereby starting to cause a component F of the gravity W exerted on the vehicle (accordingly, on the dead weights 54d, 54d of the lateral acceleration sensor 54) in the lateral direction of the vehicle body according to the height difference (the actual cant amount of the road). Therefore, the detected actual lateral acceleration Gy takes the positive value according to the component F, according to which the cant amount CANT calculated from the formula 4 also takes the positive value according to the component F.

As the deviation of the vehicle toward the right-side shoulder advances after the time t1, the height difference (accordingly, the component F) is gradually increased, whereby the detected actual lateral acceleration Gy, i.e., the value of the cant amount CANT reaches the roll-over preventing threshold value CANTref at the time t2 and kept to be the value greater than the roll-over preventing threshold value CANTref after the time t2. As a result, the condition that “the absolute value of the detected actual lateral acceleration Gy is greater than the absolute value of the estimated lateral acceleration Gyest and the absolute value of the cant amount CANT is greater than the roll-over preventing threshold value CANTref” keeps on being established after the time t2, resulting in that “the state that the vehicle is judged to be in the state of having high possibility of roll-over” is continued.

At the time t3, i.e., when “the state that the vehicle is judged to be in the state of having high possibility of roll-over” is continued by a first predetermined time T1 from the time t2, this device starts to produce an alarm for informing a user of a high possibility of the roll-over of the vehicle by utilizing the alarm 56, and further, keeps on producing the alarm after that so long as this state continues.

Moreover, at the time t4, i.e., when “the state that the vehicle is judged to be in the state of having high possibility of roll-over” is continued by a second predetermined time T2 from the time t2, this device starts to decrease the power from the engine 31 by fixing the target throttle valve opening TAt to “0” regardless of the operating amount Accp of the accelerator by the driver, and further, keeps on decreasing the power from the engine 31 after that so long as this state continues. This gently decelerates the vehicle by the engine brake generated from the engine 31.

Further, at the time t5, i.e., when “the state that the vehicle is judged to be in the state of having high possibility of roll-over” is continued by a third predetermined time T3 from the time t2, this device starts to forcibly generate predetermined braking force on each wheel by the brake fluid pressure regardless of whether the brake pedal BP is operated or not by the driver, and further, keeps on performing the process for forcibly generating the braking force after that so long as this state continues. This relatively rapidly decelerates the vehicle.

As described above, as a specific process for preventing the roll-over, this device executes only the alarm process by the alarm 56 during the period from the time t3 to the time t4, and then, during the period from the time t4 to the time t5, it executes the process for decreasing the power from the engine 31 in addition to the alarm process by the alarm 56. After the time t5, it executes the process for forcibly generating the braking force in addition to the alarm process by the alarm 56 and the process for decreasing the power from the engine 31. It is to be noted that, when the height difference (accordingly, the component F) becomes small since the driver rotates the steering 21 in a counterclockwise direction seen from the driver by a predetermined amount, and hence the detected actual lateral acceleration Gy, i.e., the value of the cant amount CANT becomes not more than the roll-over preventing threshold value CANTref, the above-mentioned specific process is stopped at this point. The means for executing the specific process corresponds to specific process executing means.

(Actual Operation)

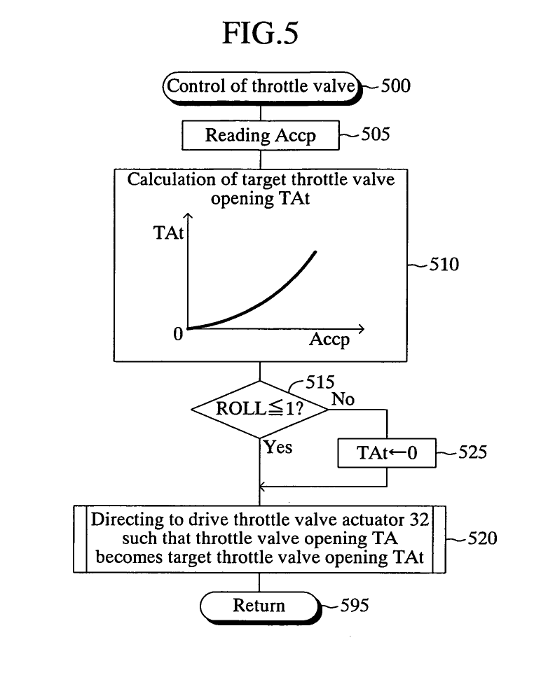

Subsequently, the actual operation of the control device 10 for a vehicle of the present invention and having the above-mentioned construction will be explained hereinbelow with reference to FIGS. 5 to 11 showing routines with flowcharts executed by the CPU 61 of the electrical control apparatus 60. The symbol “**” marked at the end of the various variables, flags, symbols or the like is a comprehensive expression of “fl”, “fr” or the like marked at the end of the various variables, flags or symbols for showing which wheel such as FR or the like is related to the various variables, flags, symbols or the like. For example, the wheel speed Vw** comprehensively represents the front-left wheel speed Vwfl, front-right wheel speed Vwfr, rear-left wheel speed Vwrl and rear-right wheel speed Vwrr.

The CPU 61 repeatedly executes a routine shown in FIG. 5 for controlling the opening TA of the throttle valve TH once every predetermined period. Accordingly, the CPU 61 starts the process from a step 500 at a predetermined timing, and then proceeds to a step 505 to read the operating amount Accp of the accelerator detected by the accelerator opening sensor 53.

Then, the CPU 61 proceeds to a step 510 to calculate the target throttle valve opening TAt based upon the above-mentioned read accelerator operating amount Accp and a table shown in the step 510 that defines the relationship between the accelerator operating amount Accp and the target throttle valve opening TAt. By this process, the target throttle valve opening TAt is calculated so as to be increased according to the increase in the accelerator operating amount Accp by the driver.

Subsequently, the CPU 61 proceeds to a step 515 to determine whether a value of a high roll continuation time indicating flag ROLL is not more than “1” or not. As described later, the high roll continuation time indicating flag ROLL represents that the period when “the state that the vehicle is judged to be in the state of having high possibility of roll-over” is continued is less than the first predetermined time T1 when the value thereof is “0”, that the period when this state is continued is not less than the first predetermined time T1 and less than the second predetermined time T2 when the value thereof is “1”, that the period when this state is continued is not less than the second predetermined time T2 and less than the third predetermined time T3 when the value thereof is “2”, and that the period when this state is continued is not less than the third predetermined time T3 when the value thereof is “3”.

The explanation is continued here assuming that “the state that the vehicle is judged to be in the state of having high possibility of roll-over” does not occur (e.g., see the period from the time t0 to the time t2 in FIG. 4) and the value of the high roll continuation time indicating flag ROLL is “0”. The CPU 61 makes “YES” determination at the step 515 and moves to a step 520 for giving a direction to the throttle valve actuator 32 to drive such that the throttle valve opening TA becomes the target throttle valve opening TAt according to the accelerator operating amount Accp calculated at the step 510, and then, proceeds to a step 595 to temporarily terminate this routine.

After that, the CPU 61 repeatedly executes the routine of FIG. 5. So long as “the state that the vehicle is judged to be in the state of having high possibility of roll-over” does not occur (or the period when this state is continued is less than the second predetermined time T2), the CPU 61 keeps on making “YES” determination at the step 515, so that the throttle valve opening TA is controlled to be the target throttle valve opening TAt according to the accelerator operating amount Accp. Therefore, the fuel injection device 33 injects fuel of an amount corresponding to the accelerator operating amount Accp by the driver, whereby the engine 31 keeps on producing the power corresponding to the accelerator operating amount Accp.

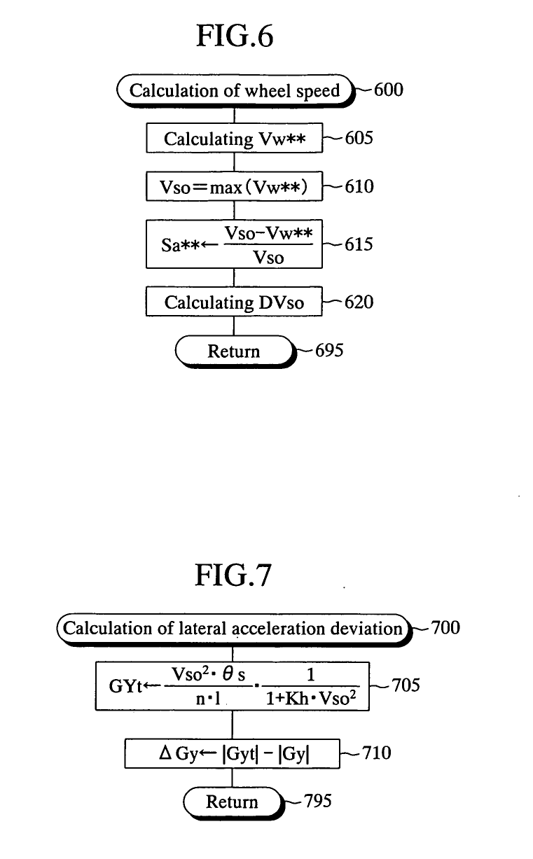

Further, the CPU 61 repeatedly executes a routine shown in FIG. 6 for calculating the wheel speed Vw** or the like once every predetermined period. Accordingly, the CPU 61 starts the process from a step 600 at a predetermined timing, and then proceeds to a step 605 to respectively calculate the wheel speed (outer peripheral speed of each wheel) Vw** of each wheel FR or the like as a motion state quantity. Specifically, the CPU 61 calculates the respective wheel speeds Vw** of each wheel FR or the like based upon a time interval of a pulse possessed by a signal outputted from each wheel speed sensor 51**.

Then, the CPU 61 moves to a step 610 to calculate the maximum value among the wheel speeds Vw** of each wheel FR as the estimated body speed Vso. It is to be noted that the average value of the wheel speeds Vw** of each wheel FR may be calculated as the estimated body speed Vso. The step 610 corresponds to body speed obtaining means.

Then, the CPU 61 moves to a step 615 to calculate an actual slip ratio Sa** of every wheel based upon the estimated body speed Vso calculated at the step 610, the value of the wheel speeds Vw** of each wheel FR or the like calculated at the step 605 and the formula described in the step 615. This actual slip ratio Sa** is used for calculating the braking force that should be exerted on each wheel as described later.

Then, the CPU 61 proceeds to a step 620 for calculating an estimated vehicle body acceleration DVso that is a time derivative value of the estimated body speed Vso based upon a formula 5 described later.

DVso=(Vso−Vsol)/Δt [Formula 5]

In the formula 5, Vso1 is the previous estimated body speed calculated at the step 610 at the time of the previous execution of this routine, while Δt is the above-mentioned predetermined time that is the operation period of this routine. Then, the CPU 61 moves to a step 695 to temporarily terminate this routine. After that, the CPU 61 repeatedly executes the steps in FIG. 6.

Subsequently explained is the calculation of the lateral acceleration deviation. The CPU 61 repeatedly executes a routine shown in FIG. 7 once every predetermined period. Accordingly, the CPU 61 starts the process from a step 700 at a predetermined timing, and then proceeds to a step 705 to calculate the target lateral acceleration Gyt based upon the value of the steering angle θs obtained by the steering angle sensor 52, the value of the estimated body speed Vso calculated at the step 610 in FIG. 6 and the formula described in the step 705 and corresponding to the right side of the formula 1. The step 705 corresponds to target lateral acceleration calculating means.

Then, the CPU 61 proceeds to a step 710 to calculate the lateral acceleration deviation ΔGy based upon the value of the target lateral acceleration Gyt, the value of the detected actual lateral acceleration Gy obtained by the lateral acceleration sensor 54 and the formula described in the step 710 and corresponding to the right side of the formula 2. Then, the CPU 61 proceeds to a step 795 to temporarily terminate this routine.

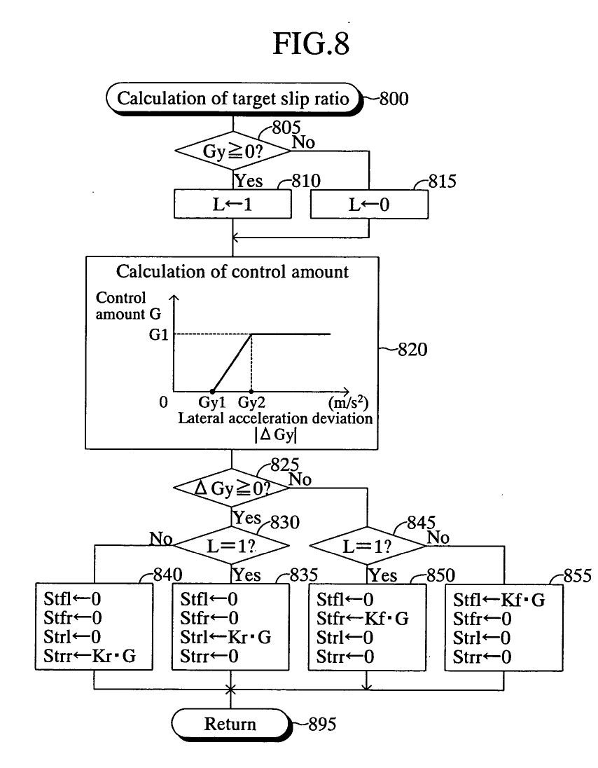

Subsequently explained is the calculation of the target slip ratio of each wheel required to determine the braking force that should be exerted on each wheel upon executing only the above-mentioned brake steering control. The CPU 61 repeatedly executes a routine shown in FIG. 8 once every predetermined period. Accordingly, the CPU 61 starts the process from a step 800 at a predetermined timing, and then proceeds to a step 805 to determine whether the value of the detected actual lateral acceleration Gy obtained by the lateral acceleration sensor 54 is not less than “0” or not. If the value of the detected actual lateral acceleration Gy is not less than “0”, the CPU 61 makes “YES” determination at the step 805, and then, moves to a step 810 to set a turning direction indicating flag L to “1”. Further, if the value of the detected actual lateral acceleration Gy is a negative value, the CPU 61 makes “NO” determination at the step 805, and then, proceeds to a step 815 to set the turning direction indicating flag L to “0”.

The turning direction indicating flag L represents here that the vehicle turns in the leftward direction or rightward direction. When the value thereof is “1”, it indicates that the vehicle turns in the leftward direction, while it indicates that the vehicle turns in the rightward direction when the value thereof is “1”. Accordingly, the turning direction of the vehicle is specified by the value of the turning direction indicating flag L.

Then, the CPU 61 moves to a step 820 to calculate a control amount G according to the value of the yawing moment that should be exerted on the vehicle with the brake steering control, based upon the absolute value of the lateral acceleration deviation ΔGy and the table described in the step 820. As shown in the table described in the step 820, the control amount G is set to “0” when the absolute value of the lateral acceleration deviation ΔGy is not more than the value Gy1. On the other hand, it is set so as to linearly change from “0” to a positive constant value G1 as the absolute value of the lateral acceleration deviation ΔGy is changed from the value Gy1 to a value Gy2 when the absolute value of the lateral acceleration deviation ΔGy is not less than the value Gy1 and not more than the value Gy2. Further, it is set so as to keep the positive constant value G1 when the absolute value of the lateral acceleration deviation ΔGy is not less than the value Gy2. In other words, the brake steering control is not executed when the absolute value of the lateral acceleration deviation ΔGy is not less than the value Gy1, while the control amount G is determined according to the absolute value of the lateral acceleration deviation ΔGy based upon the table described in the step 820 when the absolute value of the lateral acceleration deviation ΔGy is not less than the value Gy1.

Then, the CPU 61 proceeds to a step 825 to determine whether the value of the lateral acceleration deviation ΔGy calculated at the step 710 in FIG. 7 is not less than “0” or not. When the value of the lateral acceleration deviation ΔGy is not less than “0”, the CPU 61 judges that the vehicle is in the understeer state, whereby it moves to a step 830 for calculating the target slip ratio of each wheel upon executing the understeer suppressing control, thus determining whether the value of the turning direction indicating flag L is “1” or not.

When the turning direction indicating flag L is “1” in the judgement of the step 830, the CPU 61 proceeds to a step 835 to set a value obtained by multiplying a coefficient Kr that is a positive constant value by the value of the control amount G calculated at the step 820, as the target slip ratio Strl of the rear-left wheel RL, and set the target slip ratios Stfl, Stfr and Strr of the other wheels FL, FR and RR to “0”. Then, the CPU 61 proceeds to a step 895 to temporarily terminate this routine. This process allows to set the target slip ratio corresponding to the absolute value of the lateral acceleration deviation ΔGy only to the rear-left wheel RL corresponding to the inside rear wheel in the turning direction in case where the vehicle turns in the leftward direction.

On the other hand, when the turning direction indicating flag L is “0” at the judgement of the step 830, the CPU 61 moves to a step 840 to set a value obtained by multiplying the coefficient Kr by the value of the control amount G calculated at the step 820, as the target slip ratio Strr of the rear-right wheel RR, and set the target slip ratios Stfl, Stfr and Strl of the other wheels FL, FR and RL to “0”. Then, the CPU 61 proceeds to the step 895 to temporarily terminate this routine. This process allows to set the target slip ratio corresponding to the absolute value of the lateral acceleration deviation ΔGy only to the rear-right wheel RR corresponding to the inside rear wheel in the turning direction in case where the vehicle turns in the rightward direction.

On the other hand, when the value of the lateral acceleration deviation ΔGy is a negative value, the CPU 61 judges that the vehicle is in the oversteer state as previously explained, whereby it moves to a step 845 for calculating the target slip ratio of each wheel upon executing the oversteer suppressing control, thus determining whether the value of the turning direction indicating flag L is “1” or not.

When the turning direction indicating flag L is “1” in the judgement of the step 845, the CPU 61 proceeds to a step 850 to set a value obtained by multiplying a coefficient Kf that is a positive constant value by the value of the control amount G calculated at the step 820, as the target slip ratio Sffr of the front-right wheel FR, and set the target slip ratios Stfl, Strl and Strr of the other wheels FL, RL and RR to “0”. Then, the CPU 61 proceeds to the step 895 to temporarily terminate this routine. This process allows to set the target slip ratio corresponding to the absolute value of the lateral acceleration deviation ΔGy only to the front-right wheel FR corresponding to the outside front wheel in the turning direction in case where the vehicle turns in the leftward direction.

On the other hand, when the turning direction indicating flag L is “0” at the judgement of the step 845, the CPU 61 moves to a step 855 to set a value obtained by multiplying the coefficient Kf by the value of the control amount G calculated at the step 820, as the target slip ratio Stfl of the front-left wheel FL, and set the target slip ratios Stfr, Strl and Strr of the other wheels FR, RL and RR to “0”. Then, the CPU 61 proceeds to the step 895 to temporarily terminate this routine. This process allows to set the target slip ratio corresponding to the absolute value of the lateral acceleration deviation ΔGy only to the front-left wheel FL corresponding to the outside front wheel in the turning direction in case where the vehicle turns in the rightward direction. As described above, the target slip ratio of each wheel required to determine the braking force that should be exerted on each wheel upon executing only the brake steering control is determined.

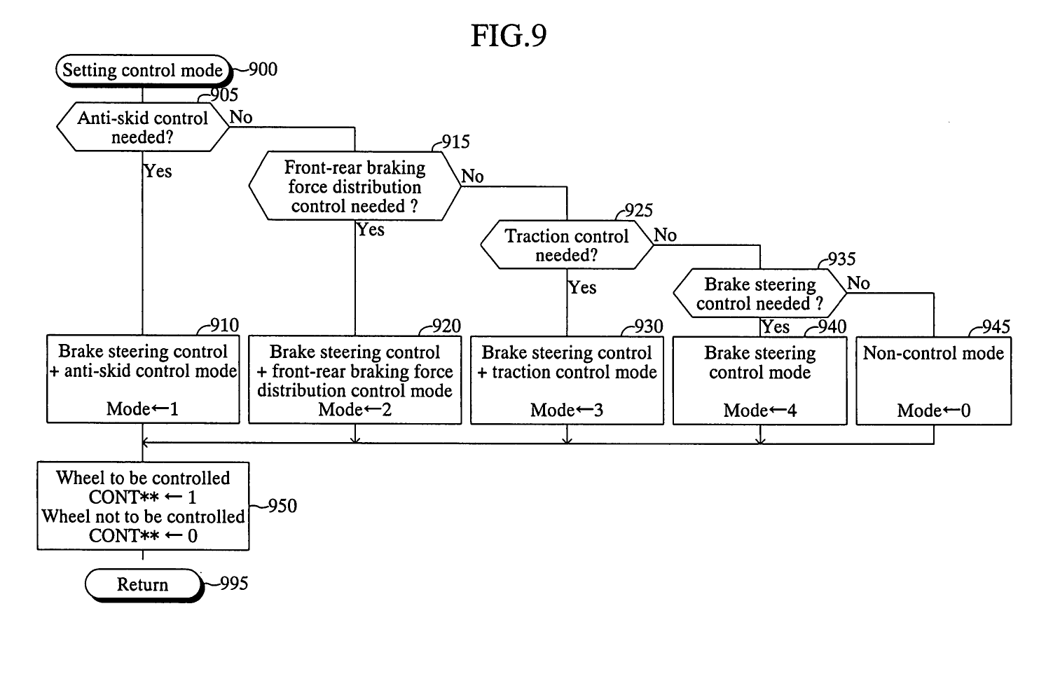

Subsequently explained is a setting of a control mode of the vehicle. The CPU 61 repeatedly executes a routine shown in FIG. 9 once every predetermined period. Accordingly, the CPU 61 starts the process from a step 900 at a predetermined timing, and then proceeds to a step 905 to determine whether the anti-skid control is necessary or not at the present. The anti-skid control is a control, when a specific wheel is locked with the brake pedal BP operated, for decreasing the braking force of the specific wheel. The detail of the anti-skid control is well-known, so that the detailed explanation thereof is omitted here.

Specifically, the CPU 61 judges that the anti-skid control is necessary in case where the state that the brake pedal BP is operated is shown by the brake switch 55 and the value of the actual slip ratio Sa** of the specific wheel calculated at the step 615 in FIG. 6 is not less than the positive predetermined value.

When the anti-skid control is judged to be necessary at the judgement of the step 905, the CPU 61 moves to a step 910 to set “1” to a variable Mode for setting a control mode that simultaneously executes the brake steering control and the anti-skid control, and then, proceeds to the following step 950.

On the other hand, when the anti-skid control is judged to be unnecessary at the judgement of the step 905, the CPU 61 moves to a step 915 to determine whether the front-rear braking force distribution control is required or not at present. The front-rear braking force distribution control is a control for decreasing a ratio (distribution) of the braking force of rear wheels to the braking force of front wheels in accordance with a value of a deceleration in the longitudinal direction of the vehicle with the brake pedal BP operated. The detail of the front-rear braking force distribution control is well-known, so that the detailed explanation thereof is omitted here.

Specifically, the CPU 61 judges at the step 915 that the front-rear braking force distribution control is needed, in case where the brake switch 55 shows that the brake pedal BP is operated and the case where the estimated body speed DVso calculated at the step 620 of FIG. 6 is a negative value and its absolute value is not less than the predetermined value.

When the front-rear braking force distribution control is needed in the judgement at the step 915, the CPU 61 proceeds to a step 920 where “2” is set to a variable Mode for setting a control mode for executing both the brake steering control and the front-rear braking force distribution control. Then, the CPU 61 proceeds to the next step 950.

When the front-rear braking force distribution control is not needed in the judgement at the step 915, the CPU 61 proceeds to a step 925 for determining whether the traction control is needed or not at present. The traction control is a control for increasing the braking force of the specific wheel or decreasing the driving force of the engine 31 in case where the specific wheel is spun in the direction where the driving force of the engine 31 is generated with the brake pedal BP not operated. The detail of the traction control is well-known, so that the detailed explanation thereof is omitted here.

Specifically, the CPU 61 judges at the step 925 that the traction control is needed, in case where the brake switch 55 shows that the brake pedal BP is not operated and the case where the actual slip ratio Sa** of the specific wheel calculated at the step 615 of FIG. 6 is a negative value and its absolute value is not less than the predetermined value.

When the traction control is needed in the judgement at the step 925, the CPU 61 proceeds to a step 930 where “3” is set to a variable Mode for setting a control mode that executes both the brake steering control and the traction control. Then, the CPU 61 proceeds to the next step 950.

When the traction control is not needed in the judgement at the step 925, the CPU 61 proceeds to a step 935 for determining whether the brake steering control is needed or not at present. Specifically, the CPU 61 determines that the brake steering control is needed at the step 935 in case where the absolute value of the lateral acceleration deviation ΔGy calculated at the step 710 in FIG. 7 is not less than the value Gy1 in the table described in the step 820 in FIG. 8, since there exists the specific wheel wherein the value of the target slip ratio St** set in FIG. 8 is not “0”.

When the brake steering control is needed in the judgement at the step 935, the CPU 61 proceeds to a step 940 where “4” is set to a variable Mode for setting a control mode executing only the brake steering control. Then, the CPU 61 proceeds to the next step 950. On the other hand, when it is determined that the brake steering control is not needed in the judgement of the step 935, the CPU 61 proceeds to a step 945 where “5” is set to a variable Mode for setting a non-control mode wherein the vehicle motion control is not executed, and then, proceeds to the next step 950. In this case, the specific wheel that should be controlled is not present.

When the CPU 61 proceeds to the step 950, it sets “1” to a flag CONT** corresponding to a wheel to be controlled, while sets “0” to a flag CONT** corresponding to a wheel not to be controlled, that is not the wheel to be controlled. The wheel to be controlled at this step 950 is a wheel that is required to control at least one of the corresponding pressure increasing valve PU** and the pressure decreasing valve PD** shown in FIG. 2.

Accordingly, in case where only the brake fluid pressure in the wheel cylinder Wfr of the front-right wheel is required to be increased, such as the case where the brake pedal BP is not operated and the program proceeds to the step 850 in FIG. 8, for example, the control valve SA1, change-over valve STR and pressure increasing valve PUfl shown in FIG. 2 are switched over to the second position and the pressure increasing valve PUfl and the pressure decreasing valve PDfr are respectively controlled, whereby only the brake fluid pressure in the wheel cylinder Wfr is increased by utilizing the high pressure generated from the high-pressure generating section 41 while keeping the brake fluid pressure in the wheel cylinder Wfl to be the fluid pressure at this time. Therefore, not only the front-right wheel FR but also the front-left wheel FL are included in the wheels to be controlled in this case. After executing the step 950, the CPU 61 proceeds to a step 995 for temporarily terminating this routine. As described above, the control mode is specified and the wheel to be controlled is specified.

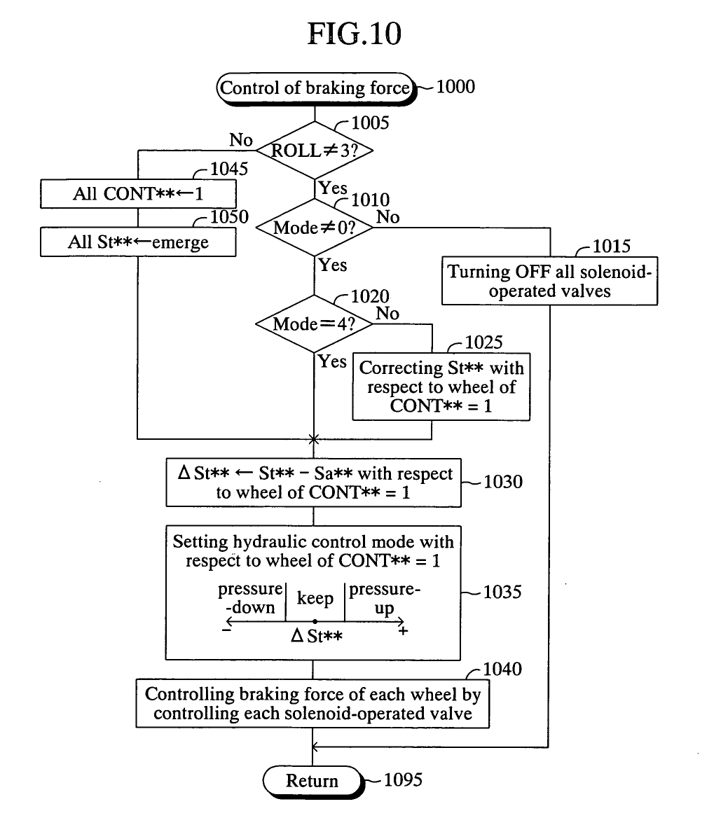

Subsequently explained is the control of the braking force that should be exerted on each driving wheel. The CPU 61 repeatedly executes the routine shown in FIG. 10 once every predetermined period. Accordingly, the CPU 61 starts the process from a step 1000 at a predetermined timing, and then, proceeds to a step 1005 to determine whether the value of the high roll continuation time indicating flag ROLL is other than “3” or not.

Since the value of the high roll continuation time indicating flag ROLL is kept to be “0” according to the previous assumption at present, the CPU 61 makes “NO” determination at the step 1005, and then, proceeds to a step 1010 for determining whether the variable Mode is not “0”. If the variable Mode is “0” here, the CPU 61 makes “NO” determination at the step 1010, and then, proceeds to a step 1015 for turning off (non-actuated state) all electromagnetic solenoids in the brake hydraulic control device 40 since the brake control is not required to be executed to each wheel. Thereafter, the CPU 61 moves to a step 1095 to temporarily terminate this routine. This allows to supply to each wheel cylinder W** brake fluid pressure according to the operating force of the brake pedal BP by the driver.

On the other hand, if the variable Mode is not “0” in the judgement at the step 1010, the CPU 61 makes “Yes” determination at the step 1010, and proceeds to a step 1020 for determining whether the variable Mode is “4” or not. If the variable Mode is not “4” (i.e., if the anti-skid control or the like that is other than the brake steering control is needed), the CPU 61 makes “YES” determination at the step 1020, and then, proceeds to a step 1025 for correcting the target slip ratio St** of each wheel that is required upon executing only the brake steering control already set in FIG. 8, with respect to the wheel to be controlled wherein the value of the flag CONT** is set to “1” at the step 950 in FIG. 9. Then, the CPU 61 moves to a step 1030. By this process, the target slip ratio St** of each wheel already set in FIG. 8 is corrected, every wheel to be controlled, by the target slip ratio of each wheel required for executing the control that is simultaneously executed with the brake steering control and corresponds to the value of the variable Mode.

If the variable Mode is “4” in the judgement at the step 1020, the CPU 61 makes “YES” determination at the step 1020, and directly moves to the step 1030, since it is unnecessary to correct the target slip ratio St** of each wheel already set in FIG. 8. Moving to the step 1030, the CPU 61 calculates a slip ratio deviation ΔSt** every wheel to be controlled based upon the value of the target slip ratio St**, the value of the actual slip ratio Sa** calculated at the step 615 in FIG. 6 and the formula disclosed in the step 1030.

Then, the CPU 61 proceeds to a step 1035 for setting a hydraulic control mode with respect to the wheel to be controlled every wheel to be controlled. Specifically, every wheel to be controlled, the CPU 61 sets the hydraulic control mode to “pressure-up” when the value of the slip ratio deviation ΔSt** exceeds the predetermined positive reference value, sets the hydraulic control mode to “keep” when the value of the slip ratio deviation ΔSt** is not less than the predetermined negative reference value but not more than the predetermined positive reference value, and sets the hydraulic control mode to “pressure-down” when the value of the slip ratio deviation ΔSt** is less than the predetermined negative reference value, based upon the value of the slip ratio deviation ΔSt** calculated at the step 1030 every wheel to be controlled and the table disclosed in the step 1035.

Subsequently, the CPU 61 proceeds to a step 1040 where it controls the control valves SA1 and SA2 and the change-over valve STR shown in FIG. 2 based upon the hydraulic control mode set at the step 1025 every wheel to be controlled and further it controls the pressure increasing valve PU** and pressure reducing valve PD** according to the hydraulic control mode every wheel to be controlled.

Specifically, the CPU 61 controls to set the corresponding pressure increasing valve PU** and pressure reducing valve PD** to the first position (position in the non-actuated state) with respect to the wheel to be controlled having the hydraulic control mode of “pressure-up”, while it controls to set the corresponding pressure increasing valve PU** to the second position (position in the actuated state) and the corresponding pressure reducing valve PD** to the first position with respect to the wheel to be controlled having the hydraulic control mode of “keep”, and further it controls to set the corresponding pressure increasing valve PU** and pressure reducing valve PD** to the second position (position in the actuated state) with respect to the wheel to be controlled having the hydraulic control mode of “pressure-down”.

This operation causes to increase the brake fluid pressure in the wheel cylinder W** of the wheel to be controlled having the hydraulic control mode of “pressure-up”, while to decrease the brake fluid pressure in the wheel cylinder W** of the wheel to be controlled having the hydraulic control mode of “pressure-down”, whereby each wheel to be controlled is controlled such that the actual slip ratio Sa** of each wheel to be controlled approaches to the target slip ratio St**. Consequently, the control corresponding to the control mode set in FIG. 9 can be achieved. The step 1040 corresponds to braking force controlling means.

It is to be noted that, when the control mode set by the execution of the routine of FIG. 9 is the control mode (variable Mode=3) for executing the traction control mode or the control mode (variable Mode=4) for executing only the brake steering control mode, the CPU 61 sets, according to need, the opening smaller than the target throttle valve opening TAt by a predetermined amount as the target throttle valve opening instead of the target throttle valve opening TAt according to the operating amount Accp of the accelerator pedal AP based upon the table described in the step 510 in FIG. 5, in order to reduce the driving force of the engine 31. By this process, the fuel injection device 33 injects fuel of an amount smaller than the amount according to the accelerator operating amount Accp by the driver, so that the engine 31 produces a power smaller than the power according to the accelerator operating amount Accp. Then, the CPU 61 proceeds to the step 1095 for temporarily terminating this routine.

After that, the CPU 61 executes the brake control based upon the target slip ratio St** of each wheel set in the routine of FIG. 8 or the target slip ratio St** of each wheel corrected at the step 1025, so long as the value of the high roll continuation time indicating flag ROLL is other than “3”.

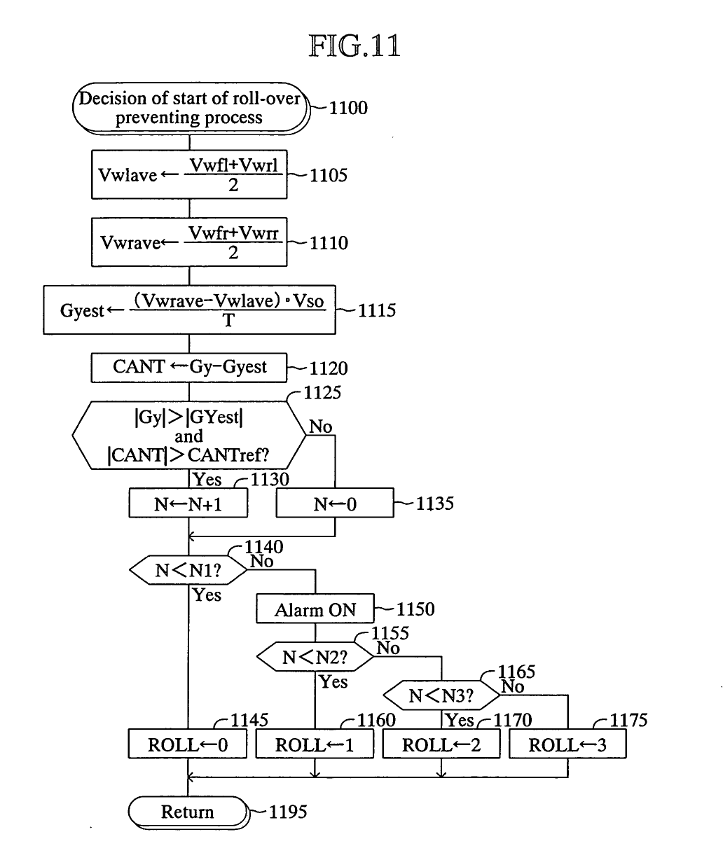

Subsequently explained is the process for determining the start of the roll-over preventing process. The CPU 61 repeatedly executes the routine shown in FIG. 11 once every predetermined period. Accordingly, the CPU 61 starts the process from a step 1100 at a predetermined timing, and then, proceeds to a step 1105 to calculate the wheel speed Vwlave of the wheels at the left side of the vehicle body, that is an average of the wheel speed Vwfl of the front-left wheel FL and the wheel speed Vwrl of the rear-left wheel RL calculated at the step 605 in FIG. 6, and calculate the wheel speed Vwrave of the wheels at the right side of the vehicle body, that is an average of the wheel speed Vwfr of the front-right wheel FR and the wheel speed Vwrr of the rear-right wheel RR calculated at the step 605 in FIG. 6.

Then, the CPU 61 proceeds to a step 1115 for calculating the estimated lateral acceleration Gyest based upon the wheel speed Vwlave of the wheels at the left side of the vehicle body, the wheel speed Vwrave of the wheels at the right side of the vehicle body, the estimated body speed Vso calculated at the step 610 in FIG. 6 and the formula described in the step 1115 and corresponding to the above-mentioned formula 3. The CPU 61 further calculates at the next step 1120 the cant amount CANT based upon the detected actual lateral acceleration Gy detected by the lateral acceleration sensor 54, the estimated lateral acceleration Gyest and the formula corresponding to the above-mentioned formula 4 and described in the step 1120.

Subsequently, the CPU 61 proceeds to a step 1125 to determine whether the following both conditions are established; the condition wherein the absolute value of the detected actual lateral acceleration Gy is greater than the absolute value of the estimated lateral acceleration Gyest and the condition wherein the absolute value of the cant amount CANT is greater than the roll-over preventing threshold value CANTref. If both conditions are not established, the CPU 61 makes “NO” determination at the step 1125, and then, moves to a step 1135 to set the value of a counter N to “0”. Thereafter, the CPU 61 moves to a step 1140.

On the other hand, when both two conditions are established in the judgement at the step 1125 (i.e., when the vehicle is in the state of having high possibility of the roll-over), the CPU 61 makes “YES” determination to move to a step 1130 for setting, as a new counter value, a value obtained by adding “1” to the value of the counter N at present, and then, moves to the step 1140. The counter value N represents the continuation time of “the state where the vehicle is determined to be in the state of having high possibility of the roll-over” due to the process of these steps 1125 to 1135.

Moving to the step 1140, the CPU 61 determines whether the value of the counter N is less than a first predetermined value N1 corresponding to the first predetermined time T1. When the value of the counter N is less than the first predetermined value N1, the CPU 61 makes “YES” determination, and then, moves to a step 1145 to set the value of the high roll continuation time indicating flag ROLL to “0”. Thereafter, the CPU 61 proceeds to a step 1195 to temporarily terminate this routine.

On the other hand, when the value of the counter N is not less than the predetermined value N1 in the judgement at the step 1140, the CPU 61 makes “NO” determination at the step 1140, and then, moves to a step 1150 to give a direction to cause an alarm for informing the user that the vehicle roll-over is highly possible. Thereafter, the CPU 61 proceeds to a step 1155 to determine whether the value of the counter N is less than a second predetermined value N2 corresponding to the second predetermined time T2 (i.e., determine whether the value of the counter N is not less than the first predetermined value N1 and less than the second predetermined value N2).

In case where the “YES” determination is made in the judgement at the step 1155, the CPU 61 proceeds to a step 1160 for setting the value of the high roll continuation time indicating flag ROLL to “1”, and then, moves to the step 1195 to temporarily terminate this routine. On the other hand, in case where the “NO” determination is made in the judgement at the step 1155, the CPU 61 moves to a step 1165 to determine whether the value of the counter N is less than a third predetermined value N3 corresponding to the third predetermined time T3 (i.e., determine whether the value of the counter N is not less than the second predetermined value N2 and less than the third predetermined value N3).

In case where the “YES” determination is made in the judgement at the step 1165, the CPU 61 proceeds to a step 1170 for setting the value of the high roll continuation time indicating flag ROLL to “2”, and then, moves to the step 1195 to temporarily terminate this routine. On the other hand, in case where the “NO” determination is made in the judgement at the step 1165 (i.e., in case where the value of the counter N is determined to be not less than the third predetermined value N3), the CPU 61 moves to a step 1175 to set the value of the high roll continuation time indicating flag ROLL to “3”, and then, proceeds to the step 1195 to temporarily terminate this routine.

By repeatedly executing this routine performing the process described above, the value of the high roll continuation time indicating flag ROLL is set to a different value according to the continuation time of “the state where the vehicle is determined to be in the state of having high possibility of the roll-over”. Since “the state where the vehicle is determined to be in the state of having high possibility of the roll-over” does not occur at present according to the previous assumption, the CPU 61 keeps on making “YES” determination repeatedly at the step 1140, so that it keeps on setting the value of the high roll continuation time indicating flag ROLL to “0”.

On the other hand, when the continuation time of “the state where the vehicle is determined to be in the state of having high possibility of the roll-over” becomes not less than the first predetermined time T1 from this state (for example, see the time t3 to t4 in FIG. 4), the CPU 61 makes “NO” determination at the step 1140 to repeatedly execute the process at the step 1150, whereby the alarm 56 keeps on producing the alarm and the value of the high roll continuation time indicating flag ROLL is set to “1” by the process at the step 1160.

Further, when the continuation time of “the state where the vehicle is determined to be in the state of having high possibility of the roll-over” becomes not less than the second predetermined time T2 from this state (for example, see the time t4 to t5 in FIG. 4), the CPU 61 causes the alarm 56 to keep on producing the alarm by the process at the step 1150 and the value of the high roll continuation time indicating flag ROLL is set to “2” by the process at the step 1170. Accordingly, after that, the CPU 61 makes “NO” determination when moving to the step 515 in FIG. 5, and then, proceeds to the step 525 to repeatedly set the value of the target throttle valve opening TAt to “0”, whereby the power of the engine 31 is reduced because the throttle valve opening TA is controlled to so as to be set to “0” at the step 520 in spite of the accelerator operating amount Accp by the driver.

Moreover, when the continuation time of “the state where the vehicle is determined to be in the state of having high possibility of the roll-over” becomes not less than the third predetermined time T3 from this state (for example, see after the time t5 in FIG. 4), the CPU 61 causes the alarm 56 to keep on producing the alarm by the process at the step 1150 and the value of the high roll continuation time indicating flag ROLL is set to “3” by the process at the step 1175. Accordingly, after that, the CPU 61 makes “NO” determination at the step 1005 in FIG. 10 in addition to the process for reducing the power from the engine 31 due to the movement to the step 525 in FIG. 5 previously explained, and then, proceeds to the step 1045.

When moving to the step 1045, the CPU 61 sets the value of all flag CONT** to “1” in order to make all wheels the subject wheels to be controlled, and further, sets the target slip ratio St** of all wheels to a positive constant value emerge at the next step 1050. Therefore, the processes at the following steps 1035 and 1040 are repeatedly executed with the target slip ratio St** of all wheels set to the positive constant value emerge, whereby braking force by the brake fluid pressure corresponding to the constant value emerge is forcibly exerted on all wheels.

As explained above, according to the control device for a vehicle of the present invention, the cant amount CANT is calculated as the difference between the detected actual lateral acceleration Gy detected by the lateral acceleration sensor 54 and the estimated lateral acceleration Gyest that is estimated based upon the difference between the wheel speed Vwlave of the wheels at the left side of the vehicle body and the wheel speed Vwrave of the wheels at the right side of the vehicle body based upon the centrifugal force due to the turning run, by utilizing the fact that the lateral acceleration sensor 54 detects, as the detected actual lateral acceleration Gy, the acceleration whose absolute value is greater that the absolute value of the actual lateral acceleration (=0) actually exerted on the vehicle (based upon the centrifugal force due to the turning run), that is running approximately straight, by the amount according to the cant amount CANT in the body roll direction of the road surface. The specific process can be started and executed for preventing that the roll angle of the vehicle becomes excessive according to the value of the cant amount CANT, i.e., by considering the state of the road surface. Accordingly, the roll angle being excessive can surely be prevented even in the case where the roll angle can be excessive with the actual lateral acceleration exerted on the vehicle (based upon the centrifugal force due to the turning run) kept to be relatively small value, such as the case where the vehicle gradually deviates, as going approximately straight, toward a shoulder of a road.

Moreover, as the above-mentioned specific process, only the alarm process by the alarm 56 is executed in case where the time, when the state that the absolute value of the cant amount CANT exceeds the roll-over preventing threshold value CANTref is continued, is not less than the first predetermined time T1 and less than the second predetermined time T2, while the process for reducing the power from the engine 31 is executed in addition to the alarm process by the alarm 56 when the time, when the above-mentioned state is continued, is not less than the second predetermined time T2 and less than the third predetermined time T3, and further, the braking force producing process by the brake fluid pressure is executed in addition to the alarm process by the alarm 56 and the process for reducing the power from the engine 31 when the time, when the above-mentioned state is continued, is not less than the third predetermined time T3. Therefore, as the possibility that the roll angle of the vehicle becomes excessive is increased, the right process can successively be executed for preventing the roll angle of the vehicle from being excessive.

The present invention is not limited to the above-mentioned embodiments. Various modifications can be applied within the scope of the present invention. For example, although the estimated lateral acceleration Gyest is calculated based upon the difference between the average wheel speed Vwlave of the wheel speed Vwfl of the front-left wheel FL and the wheel speed Vwrl of the rear-left wheel RL and the average wheel speed Vwrave of the wheel speed Vwfr of the front-right wheel FR and the wheel speed Vwrr of the rear-right wheel RR in the above-mentioned embodiment, the estimated lateral acceleration Gyest may be calculated based upon any one of the differences between the wheel speed Vwfl of the front-left wheel FL and the wheel speed Vwfr of the front-right wheel FR, between the wheel speed Vwrl of the rear-left wheel RL and the wheel speed Vwrr of the rear-right wheel RR, between the wheel speed Vwfl of the front-left wheel FL and the wheel speed Vwrr of the rear-right wheel RR and between the wheel speed Vwrl of the rear-left wheel RL and the wheel speed Vwfr of the front-right wheel FR.

Further, the estimated lateral acceleration Gyest may be calculated based upon the value obtained by multiplying the estimated body speed Vso by the yaw rate Yr obtained from a yaw rate sensor not shown.

Moreover, although the cant amount CANT is calculated based upon the difference between the detected actual lateral acceleration Gy detected by the lateral acceleration sensor 54 and the estimated lateral acceleration Gyest in the above-mentioned embodiment, the cant amount CANT may be calculated based upon the ratio of the detected actual lateral acceleration Gy to the estimated lateral acceleration Gyest.

Further, although the specific process differs depending upon the time when the state that the absolute value of the cant amount CANT exceeds the roll-over preventing threshold value CANTref is continued, it may be configured such that the same specific process is executed regardless of the time when the state that the absolute value of the cant amount CANT exceeds the roll-over preventing threshold value CANTref is continued. In this case, any one of the alarm process by the alarm 56, process for reducing the power from the engine 31 and the braking force exerting process by the brake fluid pressure, or the optional combination thereof is executed as the above-mentioned specific process.

Additionally, although the specific process is executed on condition that the absolute value of the cant amount CANT exceeds the roll-over preventing threshold value CANTref in the above-mentioned embodiment, the specific process may be executed on condition that the vehicle body speed (estimated body speed Vso) is not less than the predetermined vehicle speed in addition to that the absolute value of the cant amount CANT exceeds the roll-over preventing threshold value CANTref. In this case, it is preferable that the alarm process by the alarm 56 is executed in spite of the vehicle body speed, and that the process for reducing the power from the engine 31 and the braking force exerting process by the brake fluid pressure are executed only when the vehicle body speed is not less than the predetermined vehicle speed.

Further, although the process for decelerating the vehicle as the specific process (the process for reducing the power from the engine 31 and the braking force exerting process by the brake fluid pressure) sets the degree for decelerating the vehicle so as to be uniform regardless of the absolute value of the cant amount CANT in the above-mentioned embodiment, the degree for decelerating the vehicle may be changed according to the absolute value of the cant amount CANT (the above-mentioned height difference).

Moreover, the above-mentioned embodiment may be configured to have advancing direction controlling means for controlling the advancing direction of the vehicle such that the cant amount (the height difference) of the road surface on which the vehicle runs becomes small. In this case, the advancing direction controlling means is preferably configured to control the braking force exerted on each wheel for producing the yawing moment for turning the vehicle in either one of the directions of the left-side direction and right-side direction of the vehicle body and the direction where the contact position of the wheel is higher in the vertical direction (left-side direction of the vehicle body in FIG. 4) (for producing the predetermined braking force on only the front-left wheel in the case shown in FIG. 4, for example). Alternately, the advancing direction controlling means is preferably configured to (automatically) control the position of the steering that changes the steering angle of the steering wheel so as to turn the vehicle in either one of the directions of the left-side direction and right-side direction of the vehicle body and the direction where the contact position of the wheel is higher in the vertical direction (left-side direction of the vehicle body in FIG. 4).

Further, although the turning direction of the vehicle is determined according to the sign of the detected actual lateral acceleration Gy detected by the lateral acceleration sensor at the step 805 in FIG. 8 in the above-mentioned embodiment, the turning direction of the vehicle may be determined according to the sign of the estimated lateral acceleration Gyest calculated with the formula 3.

What is claimed is:

1. A control device for a vehicle comprising: road surface obtaining means for obtaining a value according to a height difference in the vertical direction on a road surface, on which a vehicle runs, between a contact position of wheels at the left side of the body and a contact position of wheels at the right side of the body; specific process executing means for executing a specific process for preventing a roll angle of the vehicle from being excessive when the obtained value according to the height difference becomes a value showing that the height difference is greater than a predetermined value.

2. A control device for a vehicle claimed in claim 1, wherein the road surface obtaining means is provided with:
motion state quantity obtaining means for obtaining motion state quantity showing a motion state of the vehicle;
estimated lateral acceleration calculating means for calculating, as an estimated lateral acceleration, an estimated value of a lateral acceleration that is a component of the acceleration exerted on the vehicle in the lateral direction of the vehicle body, based upon the obtained motion state quantity; and
a lateral acceleration sensor for obtaining the actual value of the lateral acceleration as an actual lateral acceleration by detecting the value of the component of external force exerted on the vehicle in the lateral direction of the vehicle body; wherein
the road surface obtaining means is configured to obtain the value according to the height difference based upon the result of the comparison between the calculated estimated lateral acceleration and the obtained actual lateral acceleration.

3. A control device for a vehicle claimed in claim 2, wherein
the road surface obtaining means is configured to obtain the value according to the height difference based upon a difference between the calculated estimated lateral acceleration and the obtained actual lateral acceleration.

4. A control device for a vehicle claimed in claim 2, wherein
the specific process executing means is configured to execute the specific process when the obtained value according to the height difference becomes the value showing that the height difference is greater than the predetermined value, and when the value of the obtained actual lateral acceleration is greater than the value of the calculated estimated lateral acceleration.

5. A control device for a vehicle claimed in claim 2, wherein
the motion state quantity obtaining means is configured so as to obtain the wheel speed of each wheel of the vehicle as the motion state quantity, and
the estimated lateral acceleration calculating means is configured to calculate the estimated lateral acceleration based upon the difference between the wheel speed of the wheels at the left side of the vehicle body and the wheel speed of the wheels at the right side of the vehicle body.

6. A control device for a vehicle claimed in claim 5, wherein
the estimated lateral acceleration calculating means is configured to calculate the estimated lateral acceleration based upon the difference between the average of the wheel speeds of the front-left and rear-left wheels and the average of the wheel speeds of the front-right and rear-right wheels.

7. A control device for a vehicle claimed in claim 1, wherein
the road surface obtaining means is configured to obtain a value showing a degree of inclination of the road surface, on which the vehicle runs, in the body roll direction as the value according to the height difference.

8. A control device for a vehicle claimed in claim 2, wherein
the road surface obtaining means is configured to obtain a value showing a degree of inclination of the road surface, on which the vehicle runs, in the body roll direction as the value according to the height difference.

9. A control device for a vehicle claimed in claim 1, wherein
the specific process executing means is configured to execute at least one of a process for producing an alarm and a process for decelerating the vehicle as the specific process.

10. A control device for a vehicle claimed in claim 2, wherein
the specific process executing means is configured to execute at least one of a process for producing an alarm and a process for decelerating the vehicle as the specific process.

11. A control device for a vehicle claimed in claim 10, wherein
the process for decelerating the vehicle includes a process for producing braking force on the wheels of the vehicle by a brake fluid pressure regardless of an operation of a brake pedal and/or a process for reducing a power from a power source of the vehicle.

12. A control device for a vehicle claimed in claim 10, wherein
the specific process differs depending upon the time when the state where the obtained value according to the height difference becomes the value showing that the height difference is greater than the predetermined value continues.
